(19) United States
(12) Patent Application Publication
(10) Pub. No.: US 2012/0162412 A1
(43) Pub. Date: Jun. 28, 2012

(54) IMAGE MATTING APPARATUS USING MULTIPLE CAMERAS AND METHOD OF GENERATING ALPHA MAPS

(75) Inventors: Ho-Won KIM, Seoul (KR); Hyun KANG, Daejeon (KR); Seung-Wook LEE, Daejeon (KR); Bon-Ki KOO, Daejeon (KR)

(73) Assignee: Electronics and Telecommunications Research Institute, Daejeon-city (KR)

(21) Appl. No.: 13/335,859

(22) Filed: Dec. 22, 2011

(30) Foreign Application Priority Data
Dec. 22, 2010 (KR) 10-2010-0132864
Apr. 21, 2011 (KR) 10-2011-0037420

(51) Int. Cl. H04N 7/18; G06K 9/62

(52) U.S. Cl. 348/135; 382/106; 348/E07.085

(57) ABSTRACT

Disclosed herein are an image matting apparatus using multiple cameras and a method of generating alpha maps. The apparatus includes a multi-camera unit, a depth estimation unit, an alpha map estimation unit, and an image matting unit. The multi-camera unit acquires a main image generated when a main camera captures an object at a specific camera angle, and acquires a plurality of sub-images generated when a sub-camera captures the object at different camera angles. The depth estimation unit estimates a depth value, corresponding to a distance between the main camera and the object, for each cluster. The alpha map estimation unit estimates an alpha map of the main image using the depth value estimated by the depth estimation unit. The image matting unit extracts a foreground from the main image using the alpha map, and performs image matting using the extracted foreground.

### CROSS REFERENCE TO RELATED APPLICATIONS

This application claims the benefit of Korean Patent Application Nos. 10-2010-0132864 and 10-2011-0037420, filed Dec. 22, 2010 and Apr. 21, 2011, respectively, which are hereby incorporated by reference in their entirety into this application.

### BACKGROUND OF THE INVENTION

1. Technical Field

The present invention relates generally to an image matting apparatus using multiple cameras and a method of generating alpha maps and, more particularly, to an image matting apparatus using multiple cameras, which estimates an alpha map of an image using multiple cameras and separates an area of interest from the image based on the estimated alpha map, and a method of generating alpha maps.

2. Description of the Related Art

Image matting is a technique that estimates an alpha map, indicative of whether each of the pixels of an image is included in a foreground (i.e., an area of interest) or in a background (i.e., a non-area of interest) using an expression of weight and generates a new image by combining the area of interest with another background using the estimated alpha map.

Image matting may be classified as a method using an active device for providing depth information such as a Time Of Flight (TOF) sensor or a stereo camera, a method using specific background information such as a blue screen, or a method using user input via a Graphical User Interface (hereinafter referred to as “GUI”).

In the fields requiring real-time and high-accuracy image matting, such as the fields of broadcasting and movies, a method of separating an area of interest from an image in a chroma-key environment in which background information has been predetermined, such as Blue Screen, is being used.

However, it is disadvantageous in that a user has to directly define a specific area as a foreground or a background and separate an area of interest from an image acquired in a daily environment, such as a natural environment, using a GUI because it is difficult to apply the chroma-key environment condition to the image.

Furthermore, when a foreground part has to be separated from an image in real time or without the help of a user in the situation in which it is difficult to apply the conditions of the chroma-key environment to the image, an area of interest may be separated from the entire image by classifying the color value of a pixel at a specific depth as the color of a foreground and the remaining color values as the color of a background using a depth sensor which provides depth information.

However, since the number of commercialized depth sensors is small and most of the sensor products provide low resolution depth information, a disadvantage arises in that it is difficult to apply them to the separation of an area of interest from an image of high resolution.

### SUMMARY OF THE INVENTION

Accordingly, the present invention has been made keeping in mind the above problems occurring in the prior art, and an object of the present invention is to provide an apparatus and method which are capable of performing image matting by extracting an alpha map of an image in an environment in which it is difficult to apply a chroma-key environment.

In order to accomplish the above object, the present invention provides an image matting apparatus using multiple cameras, including a multi-camera unit for acquiring a main image generated when a main camera captures an object at a specific camera angle and acquiring a plurality of sub-images generated when a sub-camera captures the object at different camera angles; a depth estimation unit for estimating a depth value, corresponding to a distance between the main camera and the object, for each cluster forming an object captured in the main image, by using the main image and the sub-images; an alpha map estimation unit for estimating an alpha map of the main image using the depth value estimated by the depth estimation unit; and an image matting unit for extracting a foreground from the main image using the alpha map estimated by the alpha map estimation unit, and performing image matting using the extracted foreground.

In order to accomplish the above object, the present invention provides a method of an apparatus generating an alpha map for image matting, including generating clusters, forming an object captured in a main image generated when a main camera captures the object at a specific camera angle, by clustering physically contiguous pixels, having an identical color value, in the main image; estimating a depth value, corresponding to a distance between the main camera and the object, for each cluster by using sub-images generated when a sub-camera captures the object at different camera angles; classifying physically contiguous clusters, having an identical depth value in the main image, as a cluster group, corresponding to the object that captured in the main image, based on the estimated depth value; and classifying the main image as a foreground or a background based on the depth value of the cluster group and generating an alpha map of the main image.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing the construction of an image matting apparatus according to an embodiment of the present invention;

FIG. 2 is a diagram showing the operation of a multi-camera unit according to an embodiment of the present invention;

FIG. 3 is a diagram showing the construction of an alpha map generation unit according to an embodiment of the present invention;

FIG. 4 is a diagram showing a method of calculating a depth value according to an embodiment of the present invention;

FIG. 5 is a diagram showing an image matting method according to an embodiment of the present invention;

FIG. 6 is a diagram showing a method of generating alpha maps according to an embodiment of the present invention;

FIG. 7 is a diagram showing a main image and a sub-image according to a first embodiment of the present invention;

FIG. 8 is a diagram showing a main image and a sub-image according to a second embodiment of the present invention; and

FIG. 9 is a diagram showing a main image and a sub-image according to a third embodiment of the present invention.

### DESCRIPTION OF THE PREFERRED EMBODIMENTS

Reference now should be made to the drawings, throughout which the same reference numerals are used to designate the same or similar components.

The present invention will be described in detail below with reference to the accompanying drawings. Repetitive descriptions and descriptions of known functions and constructions which have been deemed to make the gist of the present invention unnecessarily vague will be omitted below. The embodiments of the present invention are provided in order to fully describe the present invention to a person having ordinary skill in the art. Accordingly, the shapes, sizes, etc. of elements in the drawings may be exaggerated to make the description clear.

An image matting apparatus using multiple cameras and a method of generating alpha maps according to embodiments of the present invention will be described below with reference to the drawings.

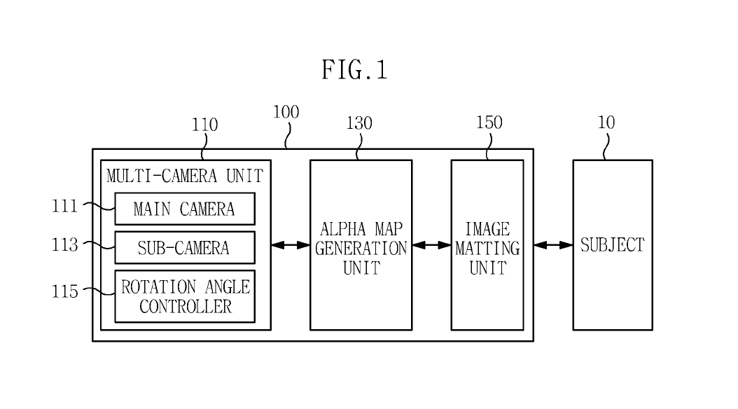

First, the image matting apparatus according to an embodiment of the present invention will now be described with reference to FIG. 1.

FIG. 1 is a diagram showing the construction of the image matting apparatus according to an embodiment of the present invention.

As shown in FIG. 1, the image matting apparatus 100 classifies objects projected onto an image of a captured subject 10, separates areas of interest from the image in which the objects are classified, and performs image matting. The image matting apparatus 100 includes a multi-camera unit 110, an alpha map generation unit 130, and an image matting unit 150.

The subject 10 is the target of an image on which image matting will be performed, and includes at least one object.

The multi-camera unit 110 captures the subject 10 using a plurality of cameras, and generates a plurality of images for the subject 10. The multi-camera unit 110 includes a main camera 111, a sub-camera 113, and a rotation angle controller 115.

The main camera 111 generates a main image by capturing the subject 10 at a specific camera angle. In the following, the camera angle indicates the angle of the lens of a corresponding camera.

The sub-camera 113 is placed in a direction perpendicular to the camera angle of the main camera 111 based on the location of the main camera 111. The sub-camera 113 generates a plurality of sub-images by capturing the subject 10 while the camera angle is being changed under the control of the rotation angle controller 115 from the location where the sub-camera 113 is placed.

The rotation angle controller 115 changes the camera angle of the sub-camera 113.

The alpha map generation unit 130 generates an alpha map of the main image using the main image (generated by the main camera 111 when the main camera 111 captures the subject 10) and the plurality of sub-images (generated by the sub-camera 113 when the sub-camera 113 captures the subject 10 while changing the camera angle).

The image matting unit 150 extracts a foreground, corresponding to an area of interest, from the main image using the alpha map generated by the alpha map generation unit 130, and performs image matting using the extracted foreground.

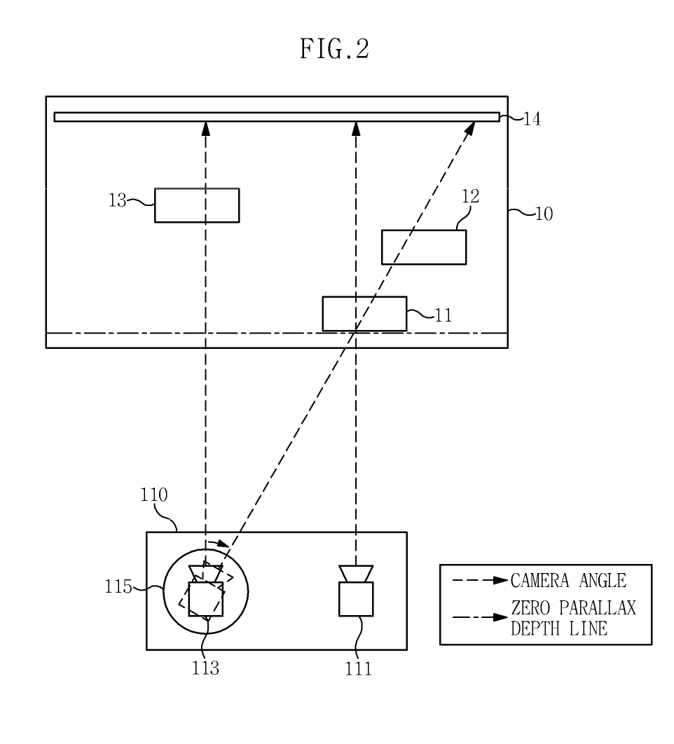

The operation of the multi-camera unit 110 of the image matting apparatus 100 according to the embodiment of the present invention will be described below with reference to FIG. 2.

FIG. 2 is a diagram showing the operation of the multi-camera unit 110 according to the embodiment of the present invention.

FIG. 2 corresponds to a plan view of the multi-camera unit 110 and the subject 10.

As shown in FIG. 2, the multi-camera unit 110 captures a plurality of images of the subject 10 by capturing the subject 10 using the main camera 111 and the sub-camera 113. Here, the subject 10 may include a plurality of objects, for example, a first object 11, a second object 12, a third object 13, and a fourth object 14. Here, the fourth object 14 may correspond to a background.

The main camera 111 generates a main image by capturing the subject 10 at a specific camera angle from the location where the main camera 111 is placed.

The sub-camera 113 is placed in a direction perpendicular to the camera angle of the main camera 111. The sub-camera 113 generates sub-images by capturing the subject 10 while the camera angle is being changed under the control of the rotation angle controller 115 at the location where the sub-camera 113 is placed. Here, the sub-camera 113 may first capture the subject 10 at the same camera angle as the main camera 111, and then capture the subject 10 at a camera angle which is changed as the rotation angle controller 115 is rotated.

The rotation angle controller 115 is placed below the sub-camera 113, and changes the camera angle of the sub-camera 113 without changing the location of the sub-camera 113.

When the camera angle of the sub-camera 113 is changed, a point of intersection at which the camera angle of the main camera 111 crosses the camera angle of the sub-camera 113 may be generated. Here, a virtual line that passes through the intersecting point between the camera angles and is perpendicular to the camera angle of the main camera 111 is referred to as a zero parallax depth line.

Here, the location of an object placed on the zero parallax depth line is the same as the locations captured in the main image and the sub-image, and pixels have the same color at a captured location.

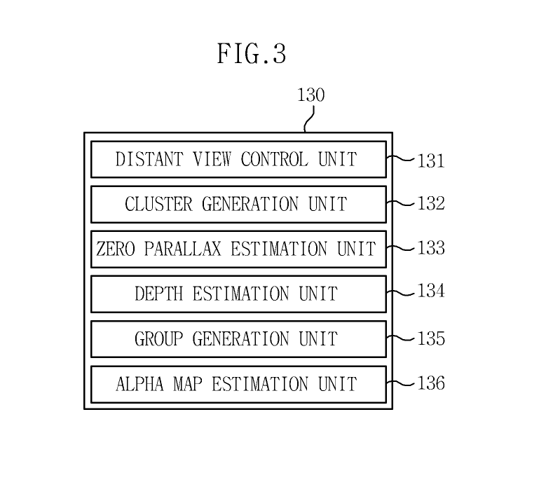

The alpha map generation unit 130 of the image matting apparatus 100 according to an embodiment of the present invention will now be described with reference to FIG. 3.

FIG. 3 is a diagram showing the construction of the alpha map generation unit 130 according to the embodiment of the present invention.

As shown in FIG. 3, the alpha map generation unit 130 includes a distant view control unit 131, a cluster generation unit 132, a zero parallax estimation unit 133, a depth estimation unit 134, a group generation unit 135, and an alpha map estimation unit 136.

The distant view control unit 131 filters out a background, corresponding to a distant view, from two images generated when the main camera 111 and the sub-camera 113 capture the subject 10 in the state in which the main camera 111 and the camera angle of the sub-camera 113 are parallel to each other.

The cluster generation unit 132 generates at least one cluster by performing clustering on the image filtered out by the distant view control unit 131 based on the color value and physical contiguous information of each pixel. Here, the cluster generation unit 132 may cluster physically contiguous pixels, selected from among pixels having the same color value, as one cluster based on the color values of the respective pixels of the images. In this case, the cluster generation unit 132 may determine color values, included in a specific range, as the same color value.

The zero parallax estimation unit 133 estimates the angle of the camera angle of the sub-camera 113 corresponding to the zero parallax depth line of a cluster included in the main image. Here, the zero parallax estimation unit 133 may search a plurality of sub-images for a sub-image having a zero parallax for a cluster corresponding to an object captured in a main image, and estimate the camera angle of the sub-camera 113, corresponding to the zero parallax depth line of the corresponding cluster, using the camera angle of the sub-camera 113 that has captured the retrieved sub-image.

The depth estimation unit 134 estimates the depth value of the cluster included in the main image. Here, if a main image and a sub-image have a zero parallax for a cluster, the depth estimation unit 134 estimates the depth value of a cluster in the main image using an angle of the camera angle of the sub-camera 113 that has captured the sub-image and also estimates the distance between the main camera 111 and the sub-camera 113. Here, if the main image and the sub-image have a zero parallax for the cluster, the cluster has the same color value and the same physical location in the main image and the sub-image.

The depth estimation unit 134 may estimate the depth value to be the distance between the main camera 111 and a zero parallax depth line, corresponding to the camera angles of the main camera 111 and the sub-camera 113.

The group generation unit 135 generates a cluster group, including one or more clusters, using the depth value of each of a plurality of clusters included in a main image. Here, the group generation unit 135 may classify physically contiguous clusters, having the same depth value, as one cluster group. Here, the cluster group generated by the group generation unit 135 may be estimated to be an object captured in the main image.

The alpha map estimation unit 136 classifies the main image as a foreground or a background based on the depth value of the cluster group generated by the group generation unit 135, and generates an alpha map of the main image.

The depth estimation unit 134 may calculate a depth value, corresponding to the distance from the main camera 111 to the zero parallax depth line, using the camera angle of the sub-camera 113 and the distance between the main camera 111 and the sub-camera 113.

Furthermore, the depth estimation unit 134 may calculate a depth value, corresponding to the distance from the main camera 111 to the point of intersection of camera angles using the camera angle of the sub-camera 113 and the distance between the main camera 111 and the sub-camera 113. Here, the point of intersection of the camera angle corresponds to a point at which the camera angle of the main camera 111 crosses the camera angle of the sub-camera 113.

The rotation angle controller 115 of the multi-camera unit 110 may finely control the camera angle of the sub-camera 113 based on the angle of the camera angle of the sub-camera 113, estimated by the zero parallax estimation unit 133, in order to improve the speed when estimating the depth value of a cluster in a main image. If the depth value for only a specific cluster selected by a user is estimated or if a depth value is estimated by tracking an object, the depth value estimation speed may be improved.

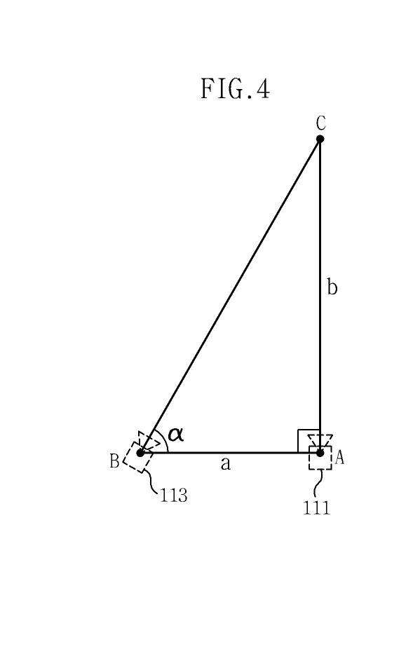

A method whereby the depth estimation unit 134 of the alpha map generation unit 130 calculates a depth value according to an embodiment of the present invention will now be described with reference to FIG. 4.

FIG. 4 is a diagram showing the method of calculating a depth value according to the embodiment of the present invention.

As shown in FIG. 4, the depth estimation unit 134 uses the characteristics of a right triangle that interconnects a first point A corresponding to the location of the main camera 111, a second point B corresponding to the location of the sub-camera 113, and a third point C corresponding to the point of intersection between the camera angle of the main camera 111 and the camera angle of the sub-camera 113.

The depth estimation unit 134 calculates a depth value b, corresponding to the distance from the location A of the main camera 111 to the point of intersection C, using the characteristics of the right triangle.

Here, the distance a between the main camera 111 and the sub-camera 113 is determined when the main camera 111 and the sub-camera 113 are arranged. Furthermore, an angle α is determined by the location of the main camera 111, the location of the sub-camera 113, and the camera angle of the sub-camera 113.

The depth estimation unit 134 may calculate the depth value b using the following Equation 1 using the characteristics of the right triangle.

b=a·tan α (1)

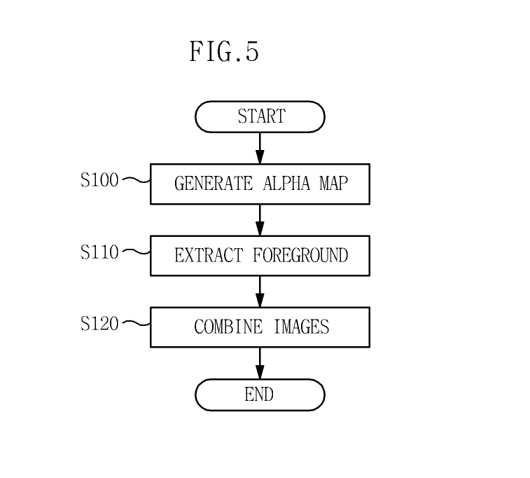

A method whereby the image matting apparatus 100 performs image matting according to an embodiment of the present invention will now be described with reference to FIG. 5.

FIG. 5 is a diagram showing the image matting method according to the embodiment of the present invention.

As shown in FIG. 5, first, the alpha map generation unit 130 generates an alpha map of a main image generated by the main camera 111 at step S100.

The image matting unit 150 extracts a foreground, corresponding to an area of interest, from the main image using the generated alpha map at step S110.

The image matting unit 150 generates a composite image by combining the extracted foreground with a new image at step S120. The new image corresponds to a background image for the extracted foreground.

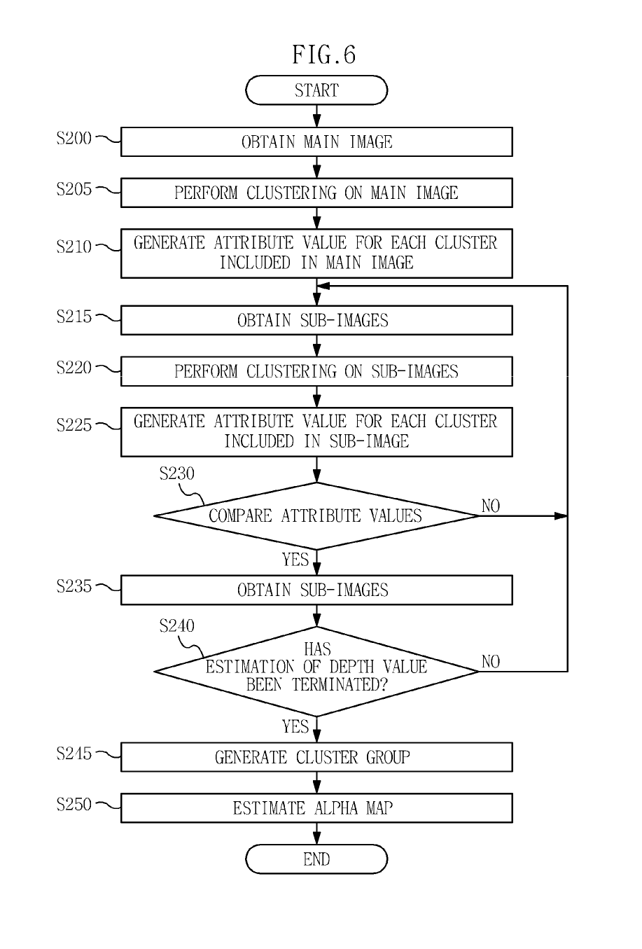

A method whereby the alpha map generation unit 130 generates an alpha map according to an embodiment of the present invention will now be described with reference to FIG. 6.

FIG. 6 is a diagram showing the method of generating alpha maps according to the embodiment of the present invention.

As shown in FIG. 6, first, the alpha map generation unit 130 acquires a main image from the multi-camera unit 110 at step S200. Here, the main image corresponds to an image generated when the main camera 111 captures the subject 10 at a specific camera angle.

Thereafter, the cluster generation unit 132 of the alpha map generation unit 130 generates one or more clusters from the main image by performing clustering on the main image at step S205. Here, the cluster generation unit 132 may classify physically contiguous pixels having the same color value, selected from among the pixels of the main image, as one cluster based on the color value of each of the pixels of the main image, and generate one or more clusters forming a captured object in the main image.

Thereafter, the cluster generation unit 132 of the alpha map generation unit 130 generates an attribute value for each of the clusters included in the main image at step S210. Here, the attribute value includes the color value of a corresponding cluster and the pixel values for pixels onto which the corresponding cluster has been projected in an image. Here, if color values fall within a specific color value range and therefore the color values are determined to be the same, the cluster generation unit 132 may set a representative color value for the corresponding color value range as the color value of the corresponding cluster. Furthermore, the cluster generation unit 132 may generate an attribute value of each of the clusters included in the main image.

Thereafter, the alpha map generation unit 130 obtains sub-images from the multi-camera unit 110 at step S215. Here, the sub-image that is obtained first corresponds to an image which is generated when the sub-camera 113 captures the subject 10 at the camera angle of a first angle, and the sub-image that is subsequently obtained corresponds to an image which is generated when the sub-camera 113 captures the subject 10 at a camera angle that the previous camera angle was rotated by a specific angle to.

Thereafter, the cluster generation unit 132 of the alpha map generation unit 130 generates one or more clusters from the sub-image by performing clustering on the sub-image at step S220. Here, the cluster generation unit 132 may classify physically contiguous pixels having the same color value as one cluster, based on the color value of each of the pixels of the sub-image, and generate one or more clusters forming an object captured in the sub-image.

Thereafter, the cluster generation unit 132 of the alpha map generation unit 130 generates an attribute value for each of the clusters included in the sub-image at step S225. Here, the attribute value includes the color value of a corresponding cluster and the pixel values for pixels onto which the corresponding cluster has been projected in an image. Here, if color values fall within a specific color value range and the color values are determined to be the same, the cluster generation unit 132 may set a representative color value for the color value range as the color value of the corresponding cluster. Furthermore, the cluster generation unit 132 may generate an attribute value for each of the clusters included in the sub-image.

Thereafter, the zero parallax estimation unit 133 of the alpha map generation unit 130 determines whether the main image and the sub-image include a zero parallax cluster corresponding to a cluster having the same attribute value by comparing the attribute value for each of the clusters included in the main image with the attribute value for each of the clusters included in the sub-image at step S230. Here, the zero parallax estimation unit 133 may search for clusters having the same attribute value. Furthermore, the zero parallax estimation unit 133 may search for clusters having the same color value and the same physical location. Here, the zero parallax estimation unit 133 may compare the attribute value for each of the clusters included in the main image with the attribute value for each of the clusters included in the sub-image.

If, as a result of the determination at step S230, it is determined that the main image and the sub-image include the zero parallax cluster, the depth estimation unit 134 estimates a depth value of the zero parallax cluster for the main image using the camera angle of the sub-camera 113 that has captured the corresponding sub-image and the distance between the main camera 111 and the sub-camera 113 at step S235.

Thereafter, the alpha map generation unit 130 determines whether estimating depth values for the clusters included in the main image will be terminated at step S240.

If, as a result of the determination at step S240, the depth values of all the clusters have been estimated, the group generation unit 135 of the alpha map generation unit 130 classifies one or more clusters as a cluster group based on the depth value for each of the clusters included in the main image and then generates one or more cluster groups in the main image at step S245. Here, the group generation unit 135 may classify physically contiguous clusters, having the same depth value in the main image as one cluster group.

Thereafter, the alpha map estimation unit 136 estimates an alpha map of the main image based on the depth value of the cluster group included in the main image at step S250. Here, the alpha map estimation unit 136 may classify the main image as a foreground or a background based on the depth value of the cluster group included in the main image and generate the alpha map of the main image. Furthermore, the alpha map estimation unit 136 may estimate an alpha map of a main image on which an object has been captured from the alpha map for the main image including the cluster group by estimating the cluster group as the object captured in the main image.

If, as a result of the determination at step S230, it is determined that the main image and the sub-image do not include the zero parallax cluster, the depth estimation unit 134 returns to step S215 at which a sub-image is obtained from the multi-camera unit 110 and then performs the steps subsequent to step S215.

If, as a result of the determination at step S240, it is determined that the depth values of all the clusters have not been estimated, the alpha map generation unit 130 returns to step S215 at which a sub-image is obtained from the multi-camera unit 110 and then performs the steps subsequent to step S215.

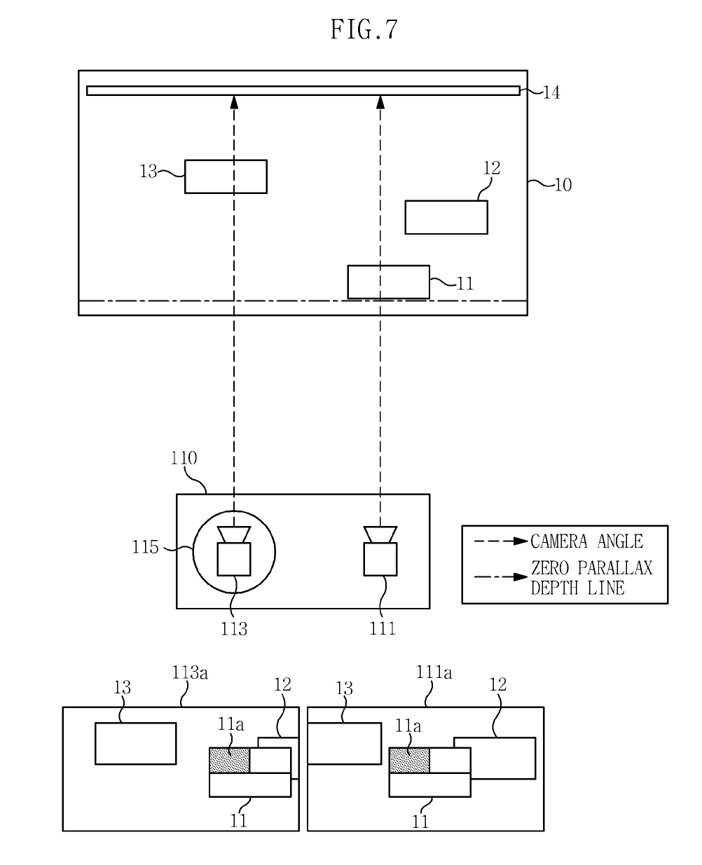

A process whereby the image matting apparatus 100 estimates the zero parallax depth line of a cluster according to embodiments of the present invention will now be described with reference to FIGS. 7 to 9.

FIG. 7 is a diagram showing a main image and a sub-image according to a first embodiment of the present invention.

As shown in FIG. 7, the multi-camera unit 110 generates a main image 111a and a sub-image 113a by capturing the subject 10 including a plurality of objects.

The subject 10 includes a first object 11, a second object 12, a third object 13, and a fourth object 14 which are arranged at different depths. Here, the front of the first object 11 has a surface which is divided into a plurality of clusters based on color values. Furthermore, the fourth object 14 corresponds to a background that is a significant distance away from the remaining objects.

The main camera 111 may generate the main image 111a onto which the first object 11, the second object 12, and the third object 13 have been projected, as shown in FIG. 7, by capturing the subject 10 at a specific camera angle. Here, the first object 11 that is projected onto the main image 111a may include a plurality of clusters, and the plurality of clusters forming the first object 11 may include a first cluster 11a.

The sub-camera 113 may generate the sub-image 113a onto which the first object 11, the second object 12, and the third object 13 have been projected, as shown in FIG. 7, by capturing the subject 10 at the same camera angle as the main camera 111. Here, the first object 11 projected onto the sub-image 113a may include a plurality of clusters, and the plurality of clusters forming the first object 11 may include the first clusters 11a.

The first clusters 11a are projected onto different locations in the main image 111a and the sub-image 113a. Accordingly, the first clusters 11a have different parallaxes when the main image 111a and the sub-image 113a are superimposed on each other.

The reason why the parallaxes are different is that the camera angle of the main camera 111 and the camera angle of the sub-camera 113 do not cross each other on a zero parallax depth line corresponding to the depth of the first object 11.

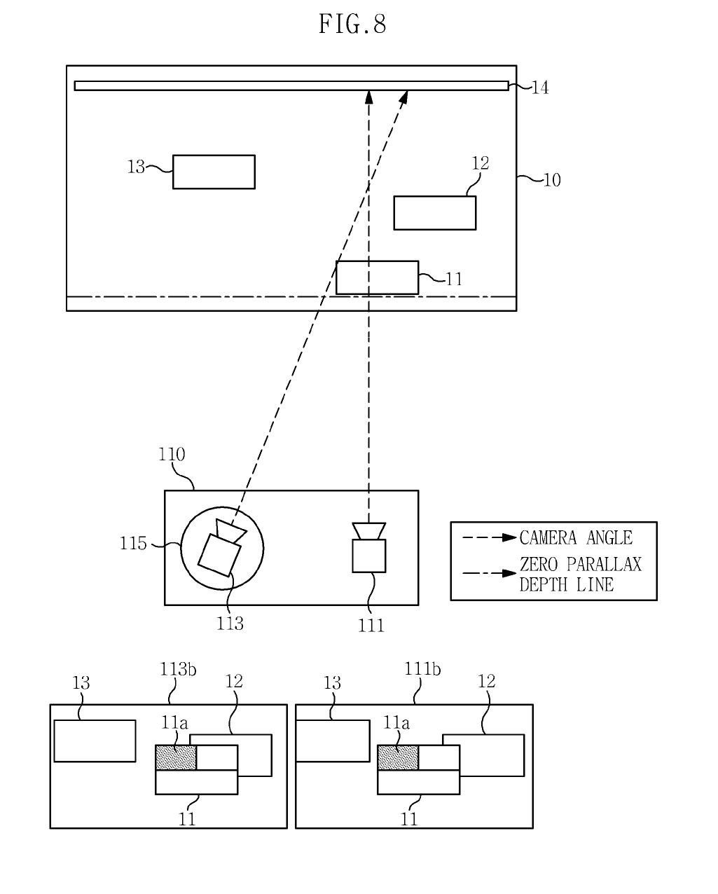

FIG. 8 is a diagram showing a main image and a sub-image according to a second embodiment of the present invention.

As shown in FIG. 8, the multi-camera unit 110 generates a main image 111b and a sub-image 113b by capturing the subject 10 including a plurality of objects.

The subject 10 includes a first object 11, a second object 12, a third object 13, and a fourth object 14 which are arranged at different depths. Here, the front of the first object 11 has a surface which is divided into a plurality of clusters based on color values. Furthermore, the fourth object 14 corresponds to a background that is a significant distant away from the remaining objects.

The main camera 111 may generate the main image 111b onto which the first object 11, the second object 12, and the third object 13 have been projected, as shown in FIG. 8, by capturing the subject 10 at a specific camera angle. Here, the first object 11 that is projected onto the main image 111b may include a plurality of clusters, and the plurality of clusters forming the first object 11 may include a first cluster 11a.

The sub-camera 113 may generate the sub-image 113b onto which the first object 11, the second object 12, and the third object 13 have been projected, as shown in FIG. 8, by capturing the subject 10 having a first camera angle. Here, the first object 11 that is projected onto the sub-image 113b may include a plurality of clusters, and the plurality of clusters forming the first object 11 may include the first cluster 11a.

The first clusters 11a are projected onto different locations in the main image 111b and the sub-image 113b. Accordingly, the first clusters 11a have different parallaxes when the main image 111b and the sub-image 113b are superimposed on each other.

The reason why the parallaxes are different is that the camera angle of the main camera 111 and the camera angle of the sub-camera 113 do not cross each other in a zero parallax depth line corresponding to the depth of the first object 11.

When the main image 111b and the sub-image 113b are superimposed on each other, the first cluster 11a that is projected onto the main image 111b and the first cluster 11a that is projected onto the sub-image 113b partially overlap each other, so that pixels having the same color value exist.

Here, if the depth value is estimated for each pixel, a depth value higher than an actual depth value is erroneously allocated to pixels having the same color value. If the depth value is estimated for each cluster, the above error is not generated.

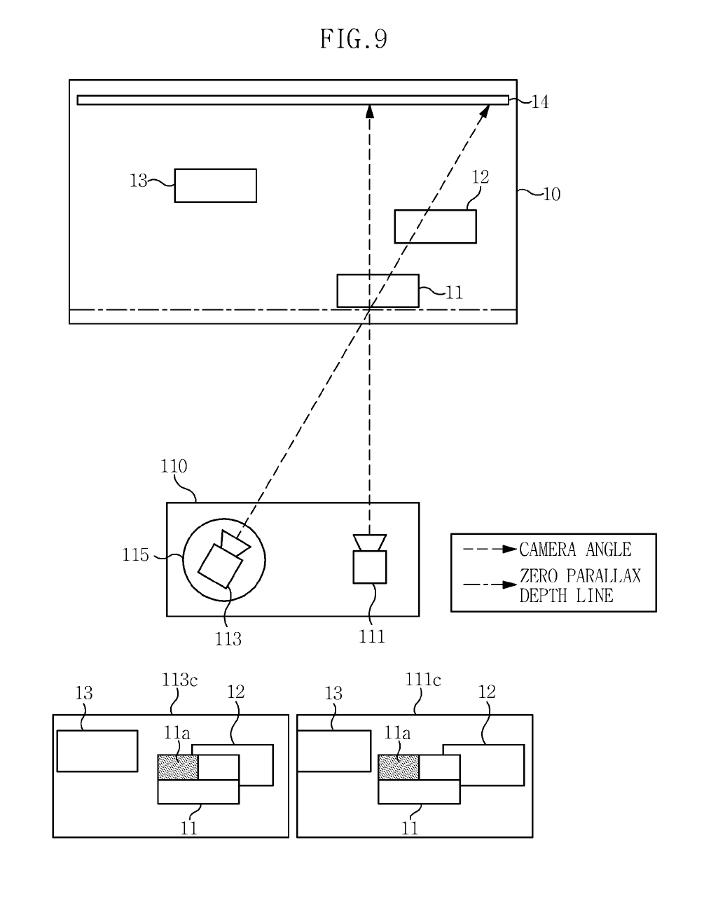

FIG. 9 is a diagram showing a main image and a sub-image according to a third embodiment of the present invention.

As shown in FIG. 9, the multi-camera unit 110 generates a main image 111c and a sub-image 113c by capturing the subject 10 including a plurality of objects.

The subject 10 includes a first object 11, a second object 12, a third object 13, and a fourth object 14 which are arranged at different depths. Here, the front of the first object 11 has a surface which is divided into a plurality of clusters based on color values. Furthermore, the fourth object 14 corresponds to a background that is a significant distance away from the remaining objects.

The main camera 111 may generate the main image 111c onto which the first object 11, the second object 12, and the third object 13 have been projected, as shown in FIG. 9, by capturing the subject 10 at a specific camera angle. Here, the first object 11 projected onto the main image 111c may include a plurality of clusters, and the plurality of clusters forming the first object 11 may include a first cluster 11a.

The sub-camera 113 may generate the sub-image 113c onto which the first object 11, the second object 12, and the third object 13 have been projected, as shown in FIG. 9, by capturing the subject 10 at a second camera angle. Here, the first object 11 projected onto the sub-image 113c may include a plurality of clusters, and the plurality of clusters forming the first object 11 may include the first cluster 11a.

Here, the camera angle of the main camera 111 and the camera angle of the sub-camera 113 cross each other on the zero parallax depth line of the first object 11, and the first clusters 11a are projected onto the same location in the main image 111b and the sub-image 113b. Accordingly, the depth value of the first cluster 11a may be accurately estimated.

As described above, according to the present invention, an alpha map for an image is generated by controlling the camera angles of multiple cameras. Accordingly, an advantage arises in that image matting can be performed by extracting an alpha map of an image in an environment in which it is difficult to apply a chroma-key environment.

Furthermore, the alpha map is generated by estimating a depth value not for each pixel but for each cluster in an image. Accordingly, the speed at which the alpha map is generated can be improved and thus the image matting speed can be improved.

Furthermore, since the depth value is calculated using an image generated by controlling the camera angle, an alpha map for the image can be generated using multiple cameras.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An image matting apparatus using multiple cameras, comprising:
a multi-camera unit for acquiring a main image generated when a main camera captures an object at a specific camera angle and acquiring a plurality of sub-images generated when a sub-camera captures the object at different camera angles;
a depth estimation unit for estimating a depth value, corresponding to a distance between the main camera and the object, for each cluster forming an object captured in the main image, by using the main image and the sub-images;
an alpha map estimation unit for estimating an alpha map of the main image by using the depth value estimated by the depth estimation unit; and
an image matting unit for extracting a foreground from the main image by using the alpha map estimated by the alpha map estimation unit, and performing image matting by using the extracted foreground.

2. The image matting apparatus as set forth in claim 1, further comprising a cluster generation unit for generating a cluster, corresponding to the object captured in the main image, by clustering pixels of the main image based on a color value for each of the pixels of the main image.

3. The image matting apparatus as set forth in claim 2, wherein the cluster generation unit clusters physically contiguous pixels having an identical color value selected from among the pixels of the main image.

4. The image matting apparatus as set forth in claim 2, further comprising a zero parallax estimation unit for searching the plurality of sub-images for a sub-image having a zero parallax for the cluster, and estimating a camera angle corresponding to the retrieved sub-image;
wherein the depth estimation unit calculates the depth value of the cluster by using the camera angle estimated by the zero parallax estimation unit.

5. The image matting apparatus as set forth in claim 4, wherein the depth estimation unit calculates the depth value of the cluster further by using a distance between the main camera and the sub-camera.

6. The image matting apparatus as set forth in claim 2, wherein the cluster generation unit clusters physically contiguous pixels each of which has a color value that falls within a specific range and which are selected from among the pixels of the main image.

7. The image matting apparatus as set forth in claim 1, further comprising a group generation unit for classifying physically contiguous clusters, having an identical depth value as a cluster group corresponding to the object that captured in the main image, based on the depth value estimated by the depth estimation unit;
wherein the alpha map estimation unit estimates the alpha map of the main image using the depth value of the cluster group.

8. The image matting apparatus as set forth in claim 1, wherein the alpha map estimation unit classifies the main image as a foreground or a background, and generates the alpha map of the main image.

9. The image matting apparatus as set forth in claim 1, wherein the multi-camera unit comprises a rotation angle controller for changing the camera angle of the sub-camera.

10. A method in which an apparatus generates an alpha map for image matting, comprising:
generating clusters, forming an object captured in a main image generated when a main camera captures the object at a specific camera angle, by clustering physically contiguous pixels, having an identical color value, in the main image;
estimating a depth value, corresponding to a distance between the main camera and the object, for each cluster by using sub-images generated when a sub-camera captures the object at different camera angles;
classifying physically contiguous clusters, having an identical depth value in the main image as a cluster group, corresponding to the object that captured in the main image, based on the estimated depth value; and
classifying the main image as a foreground or a background, based on the depth value of the cluster group and generating an alpha map of the main image.

11. The method as set forth in claim 10, wherein the estimating the depth value comprises:
generating clusters, forming an object captured in a first sub-image generated when the sub-camera captures the object at a first camera angle, by clustering physically contiguous pixels having an identical color value in the first sub-image;
searching the main image and the first sub-image for clusters having an identical color value and an identical physical location; and
calculating depth values of the retrieved clusters by using the first camera angle.

12. The method as set forth in claim 11, wherein the estimating the depth value comprises:
generating an attribute value for each of the clusters, included in the main image, by using a color value and a pixel value for each of the clusters included in the main image;
generating an attribute value for each of the clusters, included in the first sub-image, by using a color value and a pixel value for each of the clusters included in the first sub-image; and
searching for clusters having an identical color value and an identical physical location by comparing the attribute value for each of the clusters, included in the main image, with the attribute value for each of the clusters included in the first sub-image.

13. The method as set forth in claim 11, wherein the calculating the depth values comprises calculating depth values of the retrieved clusters further by using a distance between the main camera and the sub-camera.

14. The method as set forth in claim 11, wherein the generating clusters forming the object captured in the first sub-image comprises clustering physically contiguous pixels, each having a color value belonging to a specific range, based on a color value for each of the pixels of the first sub-image.

15. The method as set forth in claim 10, wherein the generating clusters forming the object captured in the main image comprises clustering physically contiguous pixels, each having a color value belonging to a specific range, based on a color value for each of the pixels of the main image.
